(19) United States
(12) Patent Application Publication
(10) Pub. No.: US 2008/0175563 A1
(43) Pub. Date: Jul. 24, 2008

(54) INFORMATION STORAGE MEDIUM STORING CONTENTS, AND METHOD AND APPARATUS FOR REPRODUCING THE CONTENTS

(75) Inventor: Young-sun YOON, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/768,463

(22) Filed: Jun. 26, 2007

(30) Foreign Application Priority Data
Jan. 24, 2007 (KR) 10-2007-0007649

(51) Int. Cl. H04N 7/26

(52) U.S. Cl. 386/111

(57) ABSTRACT

An information storage medium storing contents, and a method and apparatus for reproducing the contents which can control a trick play initiated by a user while reproducing the contents are provided. The information storage medium storing contents includes contents data formed of a plurality of sections, and contents information including position information on each contents data section and information on whether trick plays are supported.

### CROSS-REFERENCE TO RELATED PATENT APPLICATIONS

This application claims priority from Korean Patent Application No. 10-2007-0007649, filed on Jan. 24, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to reproduction of contents, and more particularly, to an information storage medium storing contents, and a method and apparatus for reproducing the contents which can control a trick play initiated by a user while reproducing the contents.

2. Description of the Related Art

In order for a user to use desired contents, there has recently been interest in a business model allowing contents to be used freely only by watching an advertisement, instead of purchasing the contents. Use of the contents is controlled by Digital Rights Management (DRM) and a license to use the contents. However, a user may want to skip the advertisement and to see the main contents and thus a method of controlling this is needed.

### SUMMARY OF THE INVENTION

The present invention provides an information storage medium storing contents, and a method and apparatus for reproducing the contents which can control a trick play initiated by a user while reproducing the contents, in order to prevent the contents from being reproduced from an arbitrary point in response to the operation of a user using the contents and to reproduce the contents from a designated position according to a content provider's desire.

According to an aspect of the present invention, there is provided an information storage medium storing contents including: contents data formed of a plurality of sections; and contents information comprising position information on each contents data section and information on whether trick plays are supported.

The contents information may further include information on a contents data section connected to a corresponding contents data section, wherein the connected contents data section is reproduced before the corresponding contents data section. The information on the connected contents data section may include flag information indicating the existence of the connected contents data section and information on a starting position of the connected contents data section.

The position information may include information on a starting position of the corresponding contents data section. The position information may further include information on an ending position of the corresponding contents data section.

The information on whether trick plays are supported may include information on whether pause, rewind, fast forward, continue play and/or halfway play of the reproduction are possible in the corresponding contents data section.

The contents information may be recorded in a form of a header of the contents.

According to another aspect of the present invention, there is provided a method of reproducing contents formed of a plurality of contents data sections, the method including: referring to position information on the contents data sections to determine a contents data section corresponding to a position where a trick play is required; and referring to information on whether trick plays are supported in the determined contents data section to determine whether the required trick play is performed.

When the required trick play is continue play or halfway play and it is determined that the connected contents data section exists, after referring to the information on the contents data sections connected to the determined contents data section, the method may further include reproducing the connected contents data section before reproducing the determined contents data section.

When another contents data section is connected to the connected contents data section, the reproducing of the connected contents data section may include reproducing the other connected contents data section before reproducing the connected contents data section.

The reproducing of the connected contents data section first may further include outputting a message indicating that continue play or halfway play is not possible from a position where the trick play is required.

When the required trick play is continue play or halfway play and it is determined that the determined contents data section should be reproduced from the starting point, by referring to the information on whether trick plays are supported, the method may further include reproducing the determined contents data section from the starting position.

When it is determined that the required trick play is not able to be performed, the method may further include outputting a message indicating that the required trick play is not performed.

According to another aspect of the present invention, there is provided an apparatus for reproducing contents formed of a plurality of contents data sections, the apparatus including: a storing unit, which stores the contents data sections, position information on each contents data section, and information on whether trick plays are supported; a section decision unit, which refers to the position information and determines a contents data section corresponding to a position where a trick play is required; a trick play determination unit, which refers to the information on whether trick plays are supported in the determined contents data section and determines whether the required trick play is performed; and a reproducing unit, which reproduces the contents and performs the required trick play under the control of the trick play determination unit.

### BRIEF DESCRIPTION OF THE DRAWINGS

The above and other aspects of the present invention will become more apparent by describing in detail exemplary embodiments thereof with reference to the attached drawings, in which:

FIG. 1 is a diagram of contents according to an exemplary embodiment of the present invention;

FIG. 2 is a diagram of contents according to another exemplary embodiment of the present invention;

FIG. 3 is a diagram of trick play support information according to an exemplary embodiment of the present invention;

FIG. 4 is a block diagram of a contents reproducing apparatus according to an exemplary embodiment of the present invention;

FIG. 5 is a flowchart illustrating a method of reproducing contents according to an exemplary embodiment of the present invention;

FIG. 6 is a flowchart illustrating a method of reproducing contents according to another exemplary embodiment of the present invention;

FIG. 7 is an example of contents header information according to an exemplary embodiment of the present invention; and

FIG. 8 illustrates the contents header information of FIG. 7 in more detail, according to an exemplary embodiment of the present invention.

### DETAILED DESCRIPTION OF EXEMPLARY EMBODIMENTS

Hereinafter, the present invention will be described more fully with reference to the accompanying drawings, in which exemplary embodiments of the invention are shown

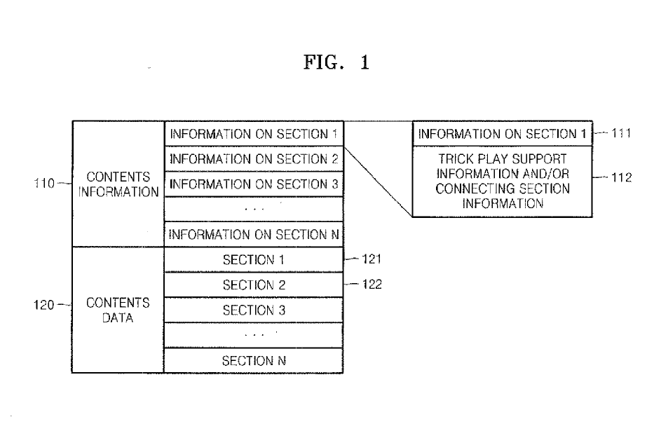

FIG. 1 is a diagram of contents according to an exemplary embodiment of the present invention.

Referring to FIG. 1, contents data 120 including media data is divided into a plurality of sections and contents information 110 including information on each contents data section is recorded. The contents information 110 includes position information 111 for searching the corresponding contents data sections and trick play support information and/or connecting section information 112 for controlling a reproducing order and a reproducing position according to a contents producer's desire.

The position information 111 includes information on a starting position of the corresponding contents data sections and may further include information on an ending position of the corresponding contents data sections. When there is no ending position, an ending position of the section can be ascertained by referring to a starting position of the next section.

Trick play support information indicates whether a trick play is supported in the corresponding contents data section, that is, whether it is possible to perform a trick play order. Information on whether a trick play is supported includes information on whether “pause”, “rewind”, “fast forward”, “continue play” and/or “halfway play” of the reproduction is possible within the corresponding contents data section. The trick play is an operation by a user who desires a special playback, instead of a general playback which reproduces the contents from a starting position, for example, “pause”, “rewind”, “fast forward”, “continue play” and/or “halfway play”. The “pause” instruction temporarily stops playback at a position designated by a user, the “rewind” instruction reproduces the contents in reverse or moves to a prior position from the current playback position, the “fast forward” instruction quickly reproduces or moves ahead from the current playback position, the “halfway play” instruction plays the contents from a specific position by using a scroll bar of a reproducing apparatus, and the “continue play” instruction plays the contents from a position where the previous playback is stopped. For example, as a result of an analysis of trick play support information, if the contents data is set to be reproduced from a starting position of a corresponding section, even if the “halfway play” or “continue play” instruction from a specific position within the section is inputted, the contents data is reproduced from the starting position of the corresponding section, instead of being reproduced from the specific position.

The connecting section information is information on a contents data section, which is connected to a corresponding contents data section. The connecting section indicates a contents data section which should be reproduced before a corresponding contents data section is reproduced. For example, when a first contents data section 121 is an advertisement image, if a connecting section information field of a second contents data section 122 is set to be connected to the first contents data section 121, skipping of an advertisement by reproducing from the second contents data section 122 can be prevented.

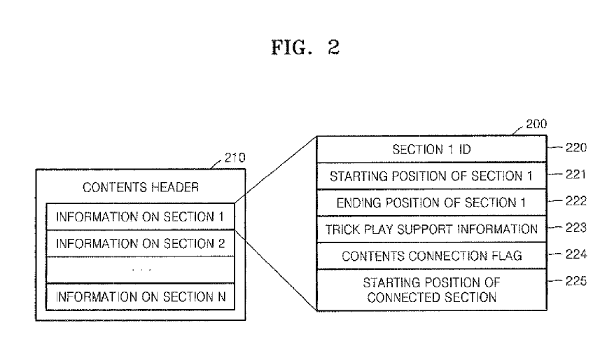

FIG. 2 is a diagram of contents according to another exemplary embodiment of the present invention.

Referring to FIG. 2, contents information is recorded in the form of a contents header 210. That is, information on contents data sections is additionally stored in the contents header 210. In information on each contents data section 200, a starting position 221 and/or an ending position 222 is recorded as position information of a corresponding section and trick play support information 223 is recorded. In addition, a flag 224 indicating whether a contents data section connected to a corresponding section exists, and a starting position of the connected contents data section 225 are recorded as connecting section information. Also, identifiers are allocated to each contents data section and the identifier 220 can be recorded in the information on each contents data section 200.

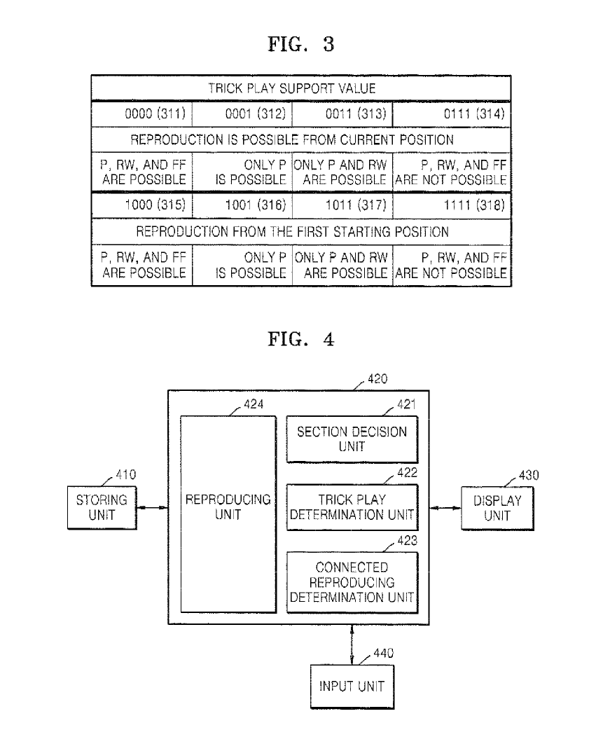

FIG. 3 is a diagram of trick play support information according to an exemplary embodiment of the present invention. In FIG. 3, eight (8) trick play values are defined. The trick play values indicate whether the contents should be reproduced from a starting point of the contents data section, or the contents can be reproduced from a current position where reproduction is required, and whether “pause (P)”, “rewind (REW)”, and “fast forward (FF)” are possible.

Referring to FIG. 3, “0000” (311) indicates that the contents can be reproduced from a current position designated by a user and “pause (P)”, “rewind (REW)”, and “fast forward (FF)” are possible. “0001”(312) indicates that the contents can be reproduced from a current position designated by a user and only “pause (P)” is possible. “0011”(313) indicates that the contents can be reproduced from a current position designated by a user and only “pause (P)” and “rewind (REW)” are possible. “0111”(314) indicates that the contents can be reproduced from a current position designated by a user and “pause (P)”, “rewind (REW)”, and “fast forward (FF)” are not possible. “1000”(315) indicates that the contents cannot be reproduced from a current position designated by a user and must be reproduced from a starting position of the corresponding section, and “pause (P)”, “rewind (REW)”, and “fast forward (FF)” are possible. “1001”(316) indicates that the contents must be reproduced from a starting position of the corresponding section and only “pause (P)” is possible. “1011”(317) indicates that the contents must be reproduced from a starting position of the corresponding section and only “pause (P)” and “rewind (REW)” are possible. “1111”(318) indicates that the contents must be reproduced from a starting position of the corresponding section and “pause (P)”, “rewind (REW)”, and “fast forward (FF)” are not possible.

FIG. 4 is a block diagram of a contents reproducing apparatus according to an exemplary embodiment of the present invention.

Referring to FIG. 4, the contents reproducing apparatus includes a storing unit 410, a control unit 420, a display unit 430, and an input unit 440. The storing unit 410 stores contents information including contents data formed of a plurality of sections, position information on each contents data section, information on whether trick play is supported and/or information on connecting sections. The control unit 420 reads out and reproduces the contents stored in the storing unit 410 and controls an operation by a user for each section. The display unit 430 outputs reproduced contents and a user interface. The input unit 440 is used by a user to input instructions.

The control unit 420 includes a section decision unit 421, a trick play determination unit 422, and a reproducing unit 424. The section decision unit 421 refers to the position information on each contents data section and determines a contents data section corresponding to a position where a reproduction or a trick play is required by user input. The trick play determination unit 422 refers to information on whether a trick play is supported in the determined contents data section and determines whether to perform an inputted trick play instruction. The reproducing unit 424 reproduces the contents and performs the inputted trick play instruction under the control of the trick play determination unit 422.

In addition, the control unit 420 may further include a connected reproducing determination unit 423 which controls the reproducing unit 424 such that connected contents data section is reproduced before the determined contents data section is reproduced. In this case, the control unit 420 refers to information on contents data sections connected to the determined contents data section, and determines whether the connected contents data sections exists. The connected reproducing determination unit 423 repeatedly checks to determine whether another contents data section is connected to the connected contents data section. When it is determined that another contents data section is connected to the connected contents data section, the connected reproducing determination unit 423 controls the reproducing unit 424 to reproduce the other contents data section before the connected contents data section is reproduced. That is, all sections connected to the corresponding sections are reproduced before the section designated by a user. The control unit 420 will be described more fully with reference to FIGS. 5 through 8.

FIG. 5 is a flowchart illustrating a method of reproducing contents according to an exemplary embodiment of the present invention.

Referring to FIG. 5, when a user inputs a trick play instruction through the input unit 440 or a “play” button is pressed and a trick play instruction instructing to “continue play” from the position at which playing was stopped is inputted, the section decision unit 421 refers to position information on a plurality of contents data sections and determines a contents data section corresponding to a position where a trick play is required in operation 502. It can be determined by calculating a value of the position where a trick play is required and comparing the value with a starting position of each section. Next, the trick play determination unit 422 refers to information on whether a trick play is supported in the determined contents data section and determines whether to perform the inputted trick play instruction in operation 504.

If it is determined that the inputted trick play instruction can be performed in operation 506, the reproducing unit 424 is controlled to perform the inputted trick play instruction in operation 508. When it is determined that the inputted trick play instruction cannot be performed in operation 506, a message showing that the inputted instruction cannot be performed is outputted to the display unit 430 in operation 509. Then, the contents are reproduced from a starting position of the corresponding contents data section or a position currently being reproduced is continuously reproduced in operation 510. For example, when “halfway play” or “continue play” is inputted in a section where these instructions are not supported, a user can reproduce the contents from a starting position of the contents data section corresponding to a position designated by a user. When “pause” or “fast forward” is inputted in a section where these instructions are not supported, the contents can be reproduced from a position where it was reproducing just before inputting an instruction.

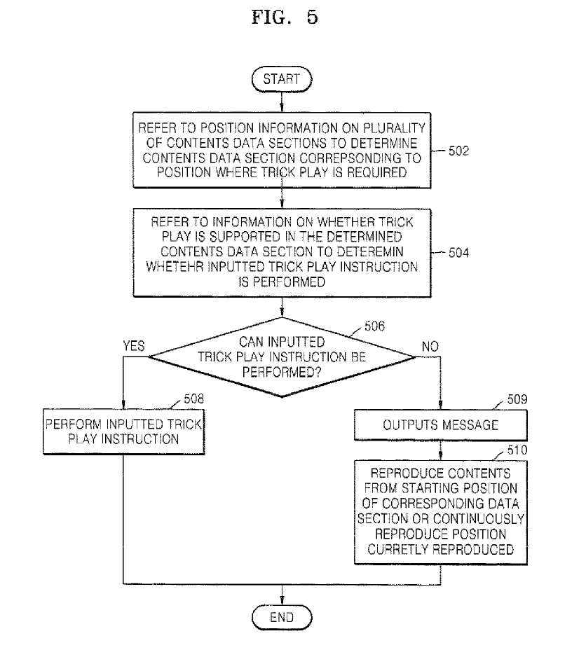

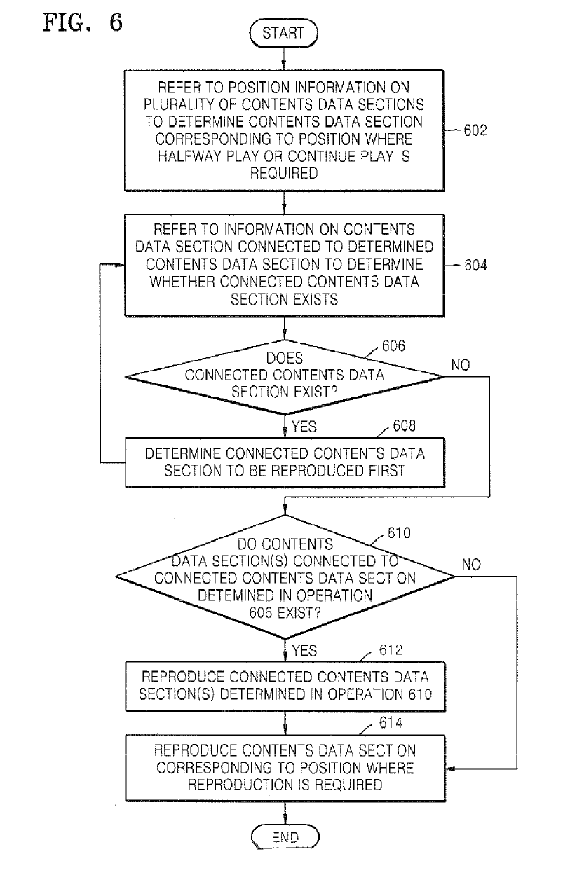

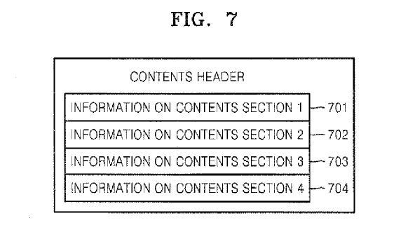

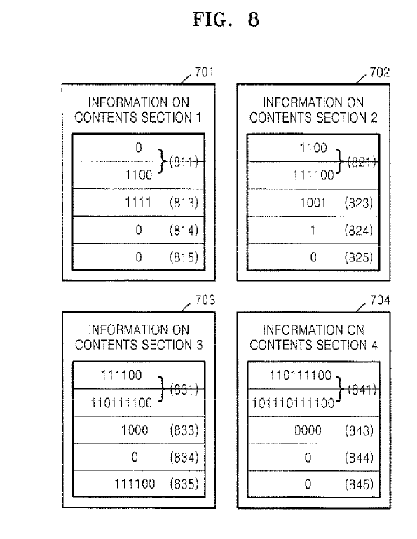

FIG. 6 is a flowchart illustrating a method of reproducing contents according to another exemplary embodiment of the present invention.

Referring to FIG. 6, when a user inputs a trick play instruction such as “halfway play” through the input unit 440 or a “play” button is pressed and a trick play instruction instructing to “continue play” from the position at which playing was previously stopped is inputted, the section decision unit 421 refers to position information on a plurality of contents data sections and determines a contents data section corresponding to a position where a “halfway play” or “continue play” is required in operation 602. Next, the connected reproducing determination unit 423 refers to information on contents data sections connected to the determined contents data section and determines whether a connected contents data section exists in operation 604. If it is determined that there exists a contents data section connected to the section corresponding to a position where a user desires to reproduce in operation 606, the connected contents data section is determined as a contents data section to be firstly reproduced in operation 608, and it is determined whether there exists another section connected to the section corresponding to the position where the user desires to reproduce in operation 604.

Operations 604 through 608 are repeatedly performed until a connected section cannot be found anymore. For example, when the value of the contents connection flag 224 is “1”, it indicates that a connected section exists. When the value of the contents connection flag 224 is “0”, a connected section does not exist. In this case, identification of the connected section is repeatedly performed until the contents data section having the value of “0” is found.

If at least one contents data section connected to the contents data section determined in operation 606 is found in operation 610, the connected reproducing determination unit 423 controls the reproducing unit 424 to reproduce this at least one section first in operation 612. The contents are reproduced in the order from the section found last to the section found first. In this case, “halfway play” or “continue play” is not possible and a message indicating that the connected section(s) is reproduced firstly may be provided to a user. In operation 614, if a contents data section connected to the contents data section determined in operation 606 is not found in operation 610, the connected reproducing determination unit 423 controls the reproducing unit 424 to reproduce a contents data section corresponding to a position where a user requires to reproduce by the inputted trick play instruction in operation 614. Here, in the case that contents information includes trick play support information, it should be determined whether the contents can be reproduced from a position where a user requires, before “halfway play” or “continue play” is performed. When the contents is set to be reproduced from a starting point of the contents data section corresponding to a position where a user requires, as a result of the determination, the contents is reproduced from a starting point of the corresponding section regardless of a user's requirement.

FIG. 7 is an example of contents header information according to an exemplary embodiment of the present invention. Referring to FIG. 7, the contents data is divided into four (4) sections and information on each contents data section 701 through 704 is recorded on the contents header.

FIG. 8 illustrates the contents header information of FIG. 7 in more detail.

Referring to FIG. 8, the positions of the contents data sections 1 through 4 in the contents data are 0˜1100 (811), 1100˜111100 (821), 111100˜110111100 (831), and 110111100˜101110111100 (841), respectively, and the trick play support value of each section is 1111 (813), 1001 (823), 1000 (833), and 0000 (843), respectively. In the information on contents data sections 2 (702), when the value of contents connection flag (824) is “1”, it indicates that a connected section exists. When the values of the contents connection flags (814, 834 and 844) are “0”, they indicate that a connected section does not exist. When the value of the contents connection flag is “0”, starting position fields (815 and 845) of the connected sections can be filled with “0”. However, in information on contents data section 3 (703), when the value of the contents connection flag is “0” and the contents data section has to be reproduced from a starting point, a starting position “111100” of the corresponding section 3 can be recorded again on a starting position field (835) of the connected section so that a reproducing position can be easily determined. In FIG. 8, the section where the connected contents data section exists is only a contents data section 2 having a contents connection flag (824) of “1”. The contents data section 2 is connected to a contents data section 1 having a starting point of “0” (825).

When a user reproduces the contents from the beginning, each section is sequentially reproduced as in a prior art. When a user reproduces the contents for approximately 10 minutes and presses the “pause” button, a reproducing apparatus calculates a value of a position designated by a user, that is, a value of the position where a “pause” instruction is inputted, and determines which contents data section includes the position. Assuming that the designated position corresponds to the contents data section 2, a reproducing apparatus searches for information on the contents data section 2 (702) stored in the header and identifies that a value of the trick play support information (823) is “1001”. Therefore, referring to an example of FIG. 3, the contents data sections 2 is a section where a “pause” is possible and thus “pause” is performed.

It is assumed that a user presses the “stop” button after 30 minutes to complete the reproduction of the contents and reproduces the contents again the next day. Here, if a user wants to skip a section that is already viewed and “continue play” the contents from the previous stop point by dragging the scroll bar of the contents reproducing apparatus to a 10 minute position, the apparatus calculates which section includes the position corresponding to the 10 minute position and determines that the position is included in the contents data section 2. The information on the contents data section 2 (702) is connected to the contents data section 1 having the starting position of “0” (825), and is the section where the contents must be reproduced from the beginning. Therefore, a message indicating that “continue play” is not possible is outputted, and the contents data section 2 is reproduced from the beginning after the contents data section 1 is reproduced.

When a user wants to reproduce the contents two (2) days later, and a position where a user designates as “halfway play” is included in the contents data section 3, information on the contents data section 3 (703) is searched. As a result of the searching, since the trick play support information (833) of the contents data section 3 is “1000”, reproduction from the current position designated by a user is not possible, and instead, the contents should be reproduced from the starting point of the corresponding section and “pause ”, “rewind” and “fast forward” are supported. In addition, the contents connection flag (834) is “0” and thus a connected section does not exist. Therefore, contents is reproduced from the starting point of the contents data section 3 “111100”. While reproducing in this section, “pause”, “rewind”, and “fast forward” are possible.

When a position where a user wants to start reproducing corresponds to the contents data section 4, the contents connection flag (844) is “0” and thus a connected section does not exist, and all trick play instructions are supported. Accordingly, the contents can be reproduced from a position where a user requires and trick plays such as “pause”, “rewind”, and “fast forward” can be freely used while viewing this section.

As described above, trick plays by a user can be controlled by each section. In particular, when an advertisement is inserted in the middle of the contents data, a user may have to view this advertisement. Therefore, the present invention can be applied to a business model which allows contents to be used freely only by seeing the advertisement. In addition, since a header in a form of a contents file is newly introduced, the present invention can be applied to a real-time streaming service and download service.

The method of the invention can be embodied as computer readable codes on a computer readable recording medium.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An information storage medium storing contents comprising:
contents data comprising a plurality of contents data sections; and
contents information on the contents, the contents information comprising:
position information on each of the contents data sections; and
information on whether a trick play is supported.

2. The information storage medium of claim 1, wherein the contents information further comprises information on a contents data section connected to a corresponding contents data section, wherein the connected contents data section is configured to be reproduced before the corresponding contents data section is reproduced.

3. The information storage medium of claim 2, wherein the information on the connected contents data section comprises:
flag information indicating whether the connected contents data section exists; and
information on a starting position of the connected contents data section.

4. The information storage medium of claim 1, wherein the position information comprises information on a starting position of a corresponding contents data section.

5. The information storage medium of claim 4, wherein the position information further comprises information on an ending position of the corresponding contents data section.

6. The information storage medium of claim 1, wherein the information on whether a trick play is supported comprises information on whether at least one of pause, rewind, fast forward, continue play and halfway play for reproducing the contents is possible in a corresponding contents data section.

7. The information storage medium of claim 1, wherein the contents information is recorded in a form of a header of the contents.

8. A method of reproducing contents comprising a plurality of contents data sections, the method comprising:
referring to position information on the contents data sections to determine a contents data section corresponding to a position where a trick play is required;
referring to information on whether the trick play is supported in the determined contents data section to determine whether to play the trick play; and
reproducing the determined contents data section according to the determining whether to play the trick play.

9. The method of claim 8, further comprising:
if the trick play is continue play or halfway play, determining whether a contents data section connected to the determined contents data section exists by referring to information on the connected contents data section; and
if it is determined that the connected contents data section exists, reproducing the connected contents data section before reproducing the determined contents data section.

10. The method of claim 9, further comprising:
determining whether another contents data section is connected to the connected contents data section; and
if it is determined that the other contents data section exists, reproducing the other connected contents data section before reproducing the connected contents data section.

11. The method of claim 9, wherein the information on the connected contents data section comprises:
flag information indicating whether the connected contents data section exists; and
information on a starting position of the connected contents data section.

12. The method of claim 9, wherein the reproducing of the connected contents data section before reproducing the determined contents data section comprises outputting a message indicating that the continue play or the halfway play is not possible from the position where the trick play is required.

13. The method of claim 8, wherein the position information comprises information on a starting position of a corresponding contents data section.

14. The method of claim 13, wherein the position information further comprises information on an ending position of the corresponding contents data section.

15. The method of claim 8, wherein the information on whether the trick play is supported comprises information on whether at least one of pause, rewind, fast forward, continue play and halfway play for reproducing the contents is possible in a corresponding contents data section.

16. The method of claim 8, further comprising:
if the trick play is continue play or halfway play, determining whether the determined contents data section should be reproduced from a starting position by referring to the information on whether the trick play is supported; and
if it is determined that the determined contents data section should be reproduced from the starting position, reproducing the determined contents data section from the starting position.

17. The method of claim 8, wherein the position information and the information on whether the trick play is supported in the determined contents data are recorded in a form of a header of the contents.

18. The method of claim 8, further comprising outputting a message indicating that the trick play is not performed, if it is determined that the trick play is not supported.

19. A computer readable recording medium having embodied thereon a computer program for executing the method of claim 8.

20. An apparatus for reproducing contents comprising a plurality of contents data sections, the apparatus comprising:
a storing unit which stores the contents data sections and contents information on the contents, the contents information comprising:
position information on each of the contents data sections, and
information on whether a trick play is supported;
a section decision unit which refers to the position information, and determines a contents data section corresponding to a position where the trick play is required;
a trick play determination unit which refers to the information on whether the trick play is supported in the determined contents data section, and determines whether to perform the trick play; and
a reproducing unit which reproduces the contents, and performs the trick play under a control of the trick play determination unit.

21. The apparatus of claim 20, further comprising a connected reproducing determination unit which determines whether a contents data section connected to the determined contents data section exists by referring to information on the connected contents data section,
wherein if the trick play is continue play or halfway play, and it is determined that the connected contents data section exists, the connected reproducing determination unit controls the reproducing unit such that the connected contents data section is reproduced before the determined contents data section is reproduced, and
wherein the contents information further comprises the information on the connected contents data section.

22. The apparatus of claim 21, wherein if another contents data section is connected to the connected contents data section, the connected reproducing determination unit controls the reproducing unit to reproduce the other connected contents data section before reproducing the connected contents data section.

23. The apparatus of claim 21, wherein the information on the connected contents data section comprises:
flag information indicating whether the connected contents data section exists; and
information on a starting position of the connected contents data section.

24. The apparatus of claim 21, wherein if the connected contents data section is reproduced before the determined contents data section is reproduced, the connected reproducing determination unit outputs a message to a display unit, the message indicating that the continue play or the halfway play is not possible from the position where the trick play is required.

25. The apparatus of claim 20, wherein the position information comprises information on a starting position of a corresponding contents data section.

26. The apparatus of claim 25, wherein the position information further comprises information on an ending position of the corresponding contents data section.

27. The apparatus of claim 20, wherein the information on whether the trick play is supported comprises information on whether at least one of pause, rewind, fast forward, continue play and halfway play for reproducing the contents is possible in a corresponding contents data section.

28. The apparatus of claim 20, wherein if the trick play is continue play or halfway play, and it is determined that the determined contents data section should be reproduced from a starting position by referring to the information on whether the trick play is supported, the trick play determination unit controls the reproducing unit to reproduce the contents from the starting position of the determined contents data section.

29. The apparatus of claim 20, wherein the contents information is recorded in a form of a header of the contents.

30. The apparatus of claim 20, wherein if it is determined that the trick play is not supported, the trick play determination unit outputs a message indicating that the trick play is not performed.
